(19) United States
(12) Patent Application Publication
(10) Pub. No.: US 2007/0139165 A1
(43) Pub. Date: Jun. 21, 2007

(54) Acoustic wave device used as RFID and as sensor

(75) Inventor: James Z.T. Liu, Belvidere, IL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/311,724

(22) Filed: Dec. 19, 2005

(51) Int. Cl. H04Q 5/22; G08B 13/14

(52) U.S. Cl. 340/10.4; 340/572.5

(57) ABSTRACT

An acoustic wave device and related systems and methods, with some embodiments comprising a device with both an acoustic wave sensor and a SAW RFID. In some embodiments, the device is powered by capturing energy from the surrounding environment without the need for an interrogating RF signal.

### FIELD OF THE INVENTION

Embodiments generally relate to acoustic wave devices used as both sensors and as radio frequency identification (RFID) devices.

### BACKGROUND

In general, it is known that piezoelectric materials produce electric charges on parts of their surfaces when they are under (compressive or tensile) strain in particular directions, and that the charge disappears when the pressure is removed. The mechanical stress produces an electric polarization that is proportional to the stress. This polarization manifests itself as a voltage across the piezoelectric material. The relationship between the electric polarization and the mechanical stress along a particular axis is known in the art. These piezoelectric materials are used in electromechanical transducers that can convert mechanical energy to electrical energy.

An interdigital transducer (IDT) is a way to excite or detect an acoustic wave on a piezoelectric substrate. For example, an IDT may comprise a plurality of parallel metal electrodes on the surface of a piezoelectric substrate alternately connected to each other via two bus bars. It can be fabricated using photolithographical methods, for example. An AC voltage applied to the bus bars causes a harmonic deformation, and acoustic waves radiate from the IDT. Similarly, an acoustic wave entering the IDT causes an RF signal between the two electrode bus bars.

A SAW (surface acoustic wave) RFID device can be a coded IDT with an antenna coupled to it. An interrogating radio signal can be received and can generate an acoustic wave. The spatial pattern of reflector IDT sections (or preferably of metal film reflector strips with SAW reflectivity capability) can reflect back a coded acoustic signal that generates a coded return RF signal. That is, the acoustic wave is partially reflected at each reflector, and converted back into an electrical signal that is transmitted by the antenna. That signal contains information about the number and location of reflectors. For example, that information can represent a binary number identifier. The RF signal is typically in the range of 50 MHz to several GHz.

An acoustic wave sensor uses an acoustic wave as the sensing mechanism. As the acoustic wave propagates through or on the surface of piezoelectric material, any changes to the characteristics of the propagation path affect the velocity or the amplitude of the wave. Changes in acoustic wave characteristics can be monitored by measuring the frequency or phase characteristics of the sensor. Such changes in the acoustic wave propagation or reflection characteristics can be correlated to the corresponding physical, electrical, or chemical parameter being measured. For example, temperature typically affects acoustic wave velocity. Mechanical parameters such as pressure, torque, and acceleration may affect the elastic deformation characteristics of the acoustic wave sensor. Impedance sensors may affect the amplitude or the phase of a reflected signal. Distance sensors may depend on signal delays. Orientation sensors may depend on measurement of Doppler phase. Other sensors may be designed to detect gas concentrations, pH, fluid flow, viscosity, density, magnetic fields, and so forth. For example, most acoustic wave chemical detection sensors rely on the mass sensitivity of the sensor in conjunction with a chemically selective coating that absorbs the vapors of interest resulting in an increased mass loading of the sensor. When these various acoustic wave sensors are wireless, they typically are powered by an interrogating RF signal.

Various modes of vibrations may exist such as, for example, a surface acoustic wave (SAW) mode, a bulk acoustic wave (BAW) mode, a flexural plate mode (FPM), an acoustic plate mode, a shear-horizontal acoustic plate mode (SH-APM), an amplitude plate mode (APM), a thickness shear mode (TSM), a torsional mode, a love wave, a leaky surface acoustic wave (LSAW) mode, a pseudo surface acoustic wave (PSAW) mode, a transverse mode, a surface-skimming mode, harmonic modes, and overtone modes. Typically, an acoustic wave device is designed so that one or more modes are optimized and other modes are suppressed.

The above applications for acoustic wave devices are discussed in various documents such as U.S. Patent Publication US 2005/0225200; U.S. Patent Publication US 2005/0226773; U.S. Patent Publication US 2005/0231067; U.S. Patent Publication US 2005/0240110; U.S. Patent Publication US 2005/0277839; X.Q. Bao et al., “Saw Temperature Sensor and Remote Reading System” (IEEE 1987 Ultrasonics Symposium, pp. 583-85); Colin K. Campbell, “Understanding Surface Acoustic Wave (SAW) Devices for Mobile and Wireless Applications and Design Techniques—Session 16: An Overview of SAW Devices for Mobile/Wireless Communications” 2004 (available at http://www3.sympatico.ca/colin.kydd.campbell/); Leonhard Reindl, “Wireless Passive SAW Identification Marks and Sensors” (2^{nd} Int. Syp. Acoustic Wave Devices for Future Mobile Communications Systems, Chiba Univ. 3^{rd}-5 Mar. 2004); and Leonhard Reindl, “Wireless Passive SAW Idenfication Marks and Sensors” (IEEE 2002 Int'l Frequency Control Symposium Tutorials, 1 Jun. 2002), that incorporated herein by reference.

It is also known that various devices can harness energy (from external sources) that otherwise would be dissipated. For example, piezoelectric devices, thermal-electric devices, magnetoelastic devices, piezoelectric-magnestoelastic devices, photo-acoustic devices, opto-electric devices, etc. can be used to capture energy depending on the ambient sources and the sources available in connection with the particular application.

### BRIEF DESCRIPTION OF THE DRAWINGS

The figures are not necessarily to scale.

FIG. 1 is a block diagram illustrating one example of the invention.

FIG. 2 is a block diagram illustrating another example of the invention.

FIG. 3 is a block diagram illustrating an example of a system embodying the invention.

FIG. 4 is a perspective view of an example of an IDT.

FIG. 5 is a cross-sectional view taken along line 5-5 of FIG. 4.

FIG. 6 is a block diagram illustrating a modification of the example of FIG. 1.

FIG. 7 is a block diagram illustrating a modification of the example of FIG. 2.

### DETAILED DESCRIPTION

While the present invention is susceptible of embodiment in various forms, there is shown in the drawings and described below some embodiments with the understanding that the present disclosure is to be considered an exemplification of the invention and is not intended to limit the invention to the specific embodiments illustrated or described.

In some embodiments of the invention, an acoustic wave device includes both an acoustic wave sensor and a SAW RFID. For example, they can use the same antenna. They also can be on the same substrate. This simplifies manufacturing, makes packaging more compact, and lowers costs.

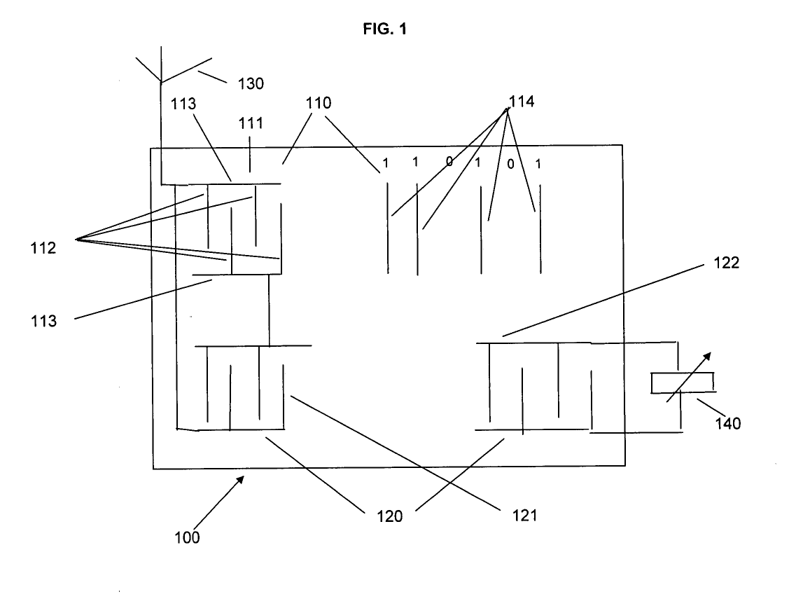

FIG. 1 is a block diagram illustrating one example of the invention. A SAW RFID 110 and a SAW resonator sensor carrier 120 are represented as part of the same device 100, and are electrically connected to the same antenna 130. In this example, the SAW RFID 110 includes an IDT section 111 with parallel metal electrodes 112 alternately connected to each other via two bus bars 113. Metal film reflector strips 114 are spaced in a way designed to represent a binary identification code. An AC voltage applied to the bus bars 113 causes a harmonic deformation, and acoustic waves radiate from IDT section 111. The spatial pattern of the reflector strips 114 reflect back a coded acoustic signal that is converted to a coded RF signal between the bus bars 113, and is transmitted by antenna 130 as an RFID.

In the example of FIG. 1, the device 100 also includes SAW resonator sensor carrier 120 with IDT sections 121 and 122. IDT section 121 is electrically connected to antenna 130 in similar fashion as is IDT section 111. A sensor 140 can be a capacitive, resistive and/or inductive sensor, and is connected as an electrical load of IDT section 122. The parameter being sensed changes the impedance of the load (i.e., sensor 140), and changes the reflection behavior of IDT section 122 and, consequently, of the RF signal from IDT section 121. While sharing the same antenna 130, SAW RFID 110 and SAW resonator sensor carrier 120 can have center frequencies that are a little different from each other.

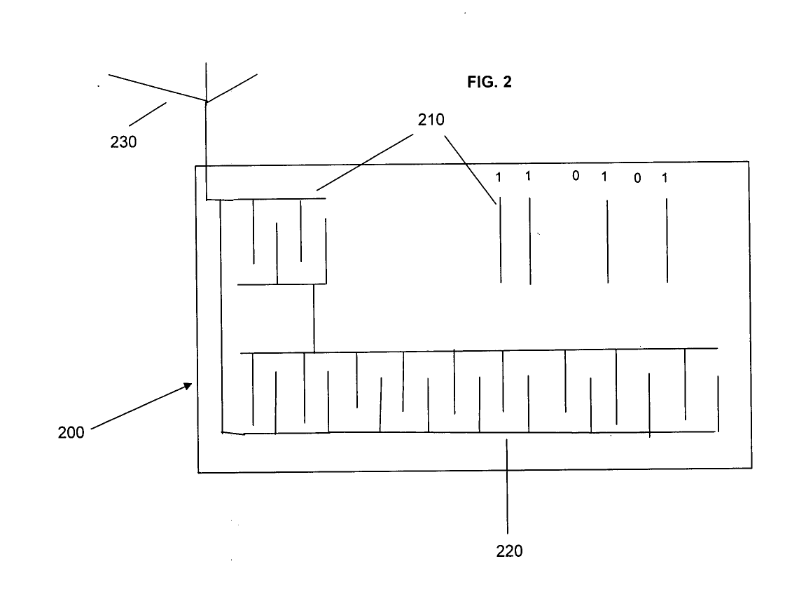

FIG. 2 is a block diagram illustrating another example of the invention. A SAW RFID 210 and a SAW sensor 220 are represented as part of the same device 200, and are electrically connected to the same antenna 230. The SAW RFID 210 represented in the example of FIG. 2 is similar to the SAW RFID 110 represented in the example of FIG. 1.

In the example of FIG. 2, the device 200 also includes a SAW sensor 220 that is shown as an IDT that is electrically connected to antenna 230 in similar fashion as is IDT section 121 in the example of FIG. 1. In the example of FIG. 2, sensor 220 can be on a substrate. As one example, sensor 220 can be a pressure sensor with the bottom of the substrate etched. That is, part of the IDT (i.e., of sensor 220) can be on an etched diaphragm that will be very sensitive to stress and strain. When that part of the substrate is properly exposed, the parameter being measured can be correlated with changes in the acoustic wave characteristics and, consequently, with the RF signal to antenna 230.

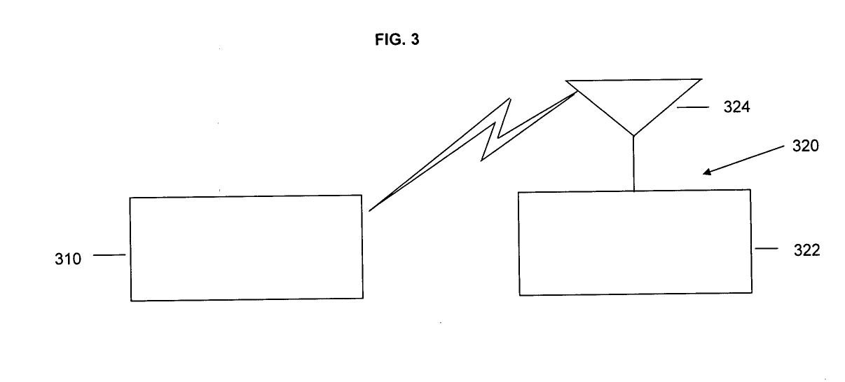

FIG. 3 is a sample illustration of a system in which an acoustic wave device 310 communicates with an information station 320. In the example of FIG. 3, information station 320 is illustrated as a receiver or a transceiver 322 connected to an antenna 324. Merely as examples, the acoustic wave device 310 can be device 100 illustrated in FIG. 1 or device 200 illustrated in FIG. 2. In accordance with the invention, both an RFID signal and a sensor signal would be made available from the acoustic wave device 310. The information station 320 includes circuitry adapted to extract the desired information from the signals anticipated from acoustic wave device 310, as is known in the art.

While the examples of FIGS. 1 and 2 each illustrates an acoustic wave device with a SAW RFID and a SAW sensor or a sensor with a SAW resonator sensor carrier, there could be multiple sensors.

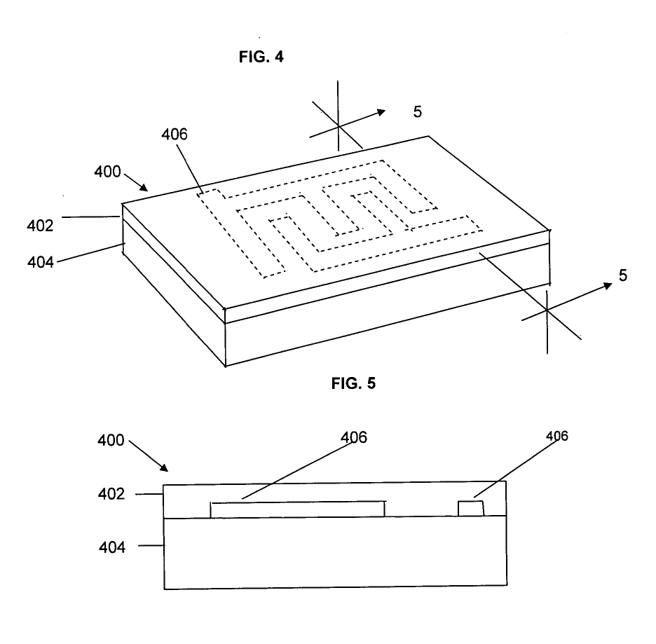

FIG. 4 illustrates a perspective view of an example of an IDT 400, and FIG. 5 is a cross-sectional view taken along line 5-5 of FIG. 4. In the example of FIGS. 4 and 5, electrodes 406 are formed on a piezoelectric substrate 404, with a coating 402. For example, coating 402 can be a chemically selective coating that absorbs vapors of interest, thereby altering the acoustic properties of IDT 400. For example, this construction would be useful for a chemical detection sensor. Coating 402 need not cover the entire surface of the piezoelectric substrate 404.

In some embodiments, multiple sensors with different coatings for sensing different chemicals could all be part of an acoustic wave device 310.

Piezoelectric substrate 404 can be formed from a variety of materials such as, for example, quartz, lithium niobate (LiNbO₃), lithium tantalite (LiTaO₃), Li₂B₄O₇, GaPO₄, langasite (La₃Ga₅SiO₁₄), ZnO, and epitaxially grown nitrides such as Al, Ga or In, to name a few. The IDT electrodes 406 can be formed from a variety of materials such as, for example, metal materials such as Al, Pt, Au, Rh, Ir, Cu, Ti, W, Cr, or Ni; alloys such as NiCr or CuAl; or metal-nonmetal compounds such as ceramics based on TiN, CoSi₂, or WC.

In some embodiments of an acoustic wave device 310, different vibration modes of an IDT (such as the example of IDT 400) can be used to sense different parameters respectively.

In the example of FIG. 3, an acoustic wave device 310 can be powered by an interrogating RF signal transmitted by a transceiver 322 in some embodiments. However, in some embodiments, sensor information and identification information can be sent from an acoustic wave device 310 to a receiver 322 without an RF request. In that case, the signal to noise level, and consequently the transmitting distance, is increased. An acoustic wave device 310 can be self-powered by capturing energy from the surrounding environment without the need for an interrogating RF signal. Various devices can harness energy that would otherwise be dissipated. For example, piezoelectric devices, thermal-electric devices, magnetoelastic devices, piezoelectric-magnetoelastic devices, photo-acoustic devices, opto-electric devices, etc. can be used to capture energy depending on the ambient sources and the sources available in connection with the particular application.

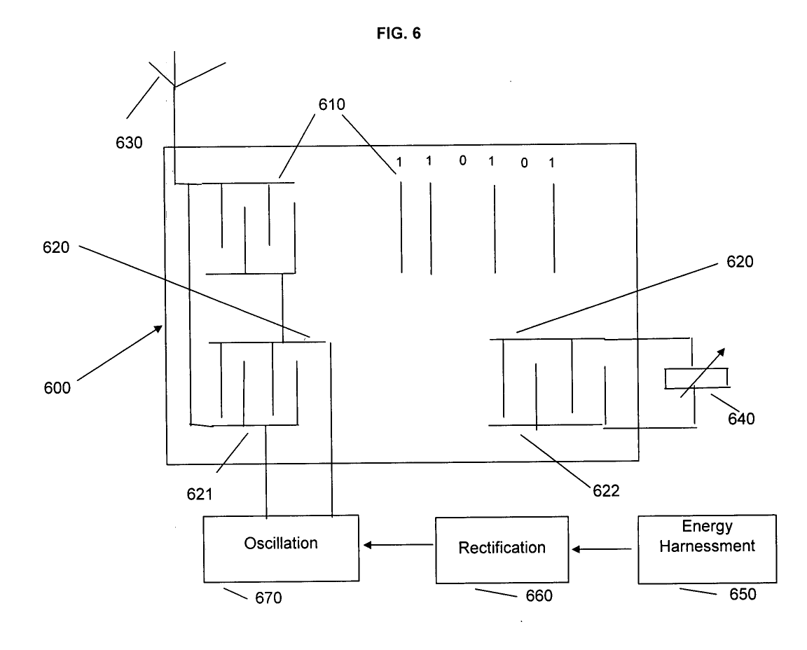

FIG. 6 is a block diagram illustrating a modification of the example of FIG. 1. As in the example of FIG. 1, SAW RFID 610 and a SAW resonator sensor carrier 620 are represented as part of the same device 600, and are electrically connected to the same antenna 630. Sensor carrier 620 includes IDT sections 621 and 622. IDT section 621 is electrically connected to antenna 630. A sensor 640 is connected as an electrical load of IDT section 622. The parameter being sensed changes the impedance of the load, and changes the reflection behavior of IDT section 622 and, consequently, of the RF signal from IDT section 621.

However, FIG. 6 illustrates the addition of an energy capturing element 650, that is designed to convert to useful electrical energy some other energy available in the particular application. For example, this might be a thermal-electric device that can utilize available heat energy. As another example, element 650 might be a resonating structure (with a piezoelectric layer) that is designed to respond to a characteristic frequency of an available vibrating source, or that is designed with a resonant frequency within the range of miscellaneous ambient noise. The mechanical stress in the piezoelectric material produces an electric polarization that manifests itself as a voltage across the piezoelectric material. As an example, such a resonating structure could be a cantilevered beam fabricated using integrated circuit technology.

For example, a typical process can start with a silicon wafer with silicon dioxide (SiO₂) layers (typically about 2 micrometers thick) formed on the top and bottom sides using a wet oxidization process. A bottom electrode can then be formed on the top side, by deposition of titanium (Ti) and platinum (Pt) layers using a sputtering process, followed by an optional electrode patterning step. The Ti is typically about 50 nanometers thick and serves as an adhesion layer, and the electrode metal Pt is typically a few hundred nanometers thick. Next, a piezoelectric film (typically 0.1 to 5 micrometers thick) is deposited. For example, three micrometers of Lead Zirconate Titanate (PZT) films can be deposited by repeated sol-gel processes. A top electrode can then be deposited on top of the piezoelectric film by same process as was used for the bottom electrode. The top-side device pattern of the top electrode, the piezoelectric film, the bottom electrode, and the resonant beam can be formed subsequently by using standard photolithography patterning techniques and a combination of wet and/or dry etch processes. An optional proof mass can be fabricated at wafer scale using processes such as a UV-LIGA or an SU-8 process combined with metal (such as nickel (Ni)) plating.

After the top-side process, the top side can be protected before proceeding to a bottom-side process of selectively removing bulk silicon (Si) from the bottom to form the cantilever beam resonator with desired thickness. A typical method used for such a Si micromachining step is to pattern the SiO₂ on the bottom-side, and then to etch the exposed Si regions using wet chemical (such as potassium hydroxide (KOH)) solutions.

Continuing with FIG. 6, a voltage across energy capturing element 650 can be applied to a rectification element 660 (such as rectifying or power regulating circuitry, etc.), and then to an oscillation element 670 (such as oscillator and other electronic circuitry, etc.) to achieve an RF signal that is appropriate for powering the SAW RFID 610 and the SAW sensor carrier 620.

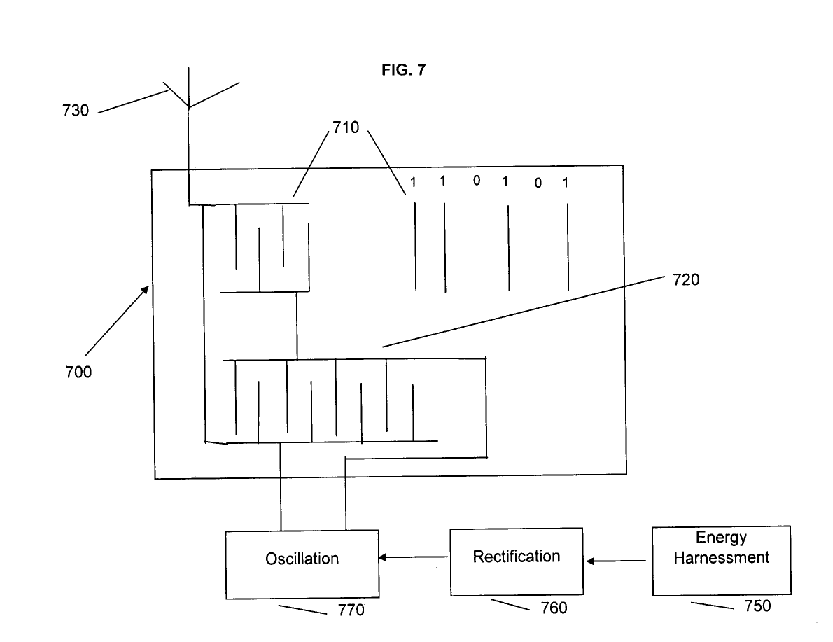

FIG. 7 is a block diagram illustrating a modification of the example of FIG. 2. As in the example of FIG. 2, SAW RFID 710 and a SAW sensor 720 are represented as part of the same device 700, and are electrically connected to the same antenna 730. However, FIG. 7 illustrates the addition of an energy capturing element 750, that is designed to convert to useful electrical energy some other energy available in the particular application. This can be similar to the energy capturing element 650 as discussed above. A voltage across energy capturing element 750 can be applied to a rectification element 760 (similar to element 660), and then to an oscillation element 770 (similar to element 670) to achieve an RF signal that is appropriate for powering the SAW RFID 710 and the SAW sensor 720.

From the foregoing it will be observed that modifications and variations can be effectuated without departing from the true spirit and scope of the novel concepts of the present invention. It is to be understood that no limitation with respect to specific embodiments shown or described is intended or should be inferred.

What is claimed is:

1. An acoustic wave device comprising:
an antenna;
an acoustic wave radio frequency identification portion;
an acoustic wave sensor portion;
the acoustic wave radio frequency identification portion electrically connected to the antenna;
the acoustic wave sensor portion electrically connected to the antenna;
the acoustic wave radio frequency identification portion capable of reflecting back a coded acoustic signal when an acoustic wave is generated in the acoustic wave radio frequency identification portion;
the acoustic wave radio frequency identification portion capable of converting the coded acoustic signal to a coded RF signal;
the acoustic wave sensor portion capable of modifying a characteristic of a sensor acoustic wave, depending on a parameter being sensed;
the acoustic wave sensor portion capable of generating a sensor RF signal containing information about the parameter being sensed.

2. The acoustic wave device as in claim 1,
wherein at least part of the device comprises an interdigital transducer section;
the interdigital transducer section capable of converting an acoustic wave into an RF signal.

3. The acoustic wave device as in claim 1,
wherein at least part of the device comprises an interdigital transducer section;
the interdigital transducer section comprising a plurality of metal electrodes.

4. The acoustic wave device as in claim 1,
wherein the acoustic wave radio frequency identification portion comprises a spatial pattern of metal film reflector strips with acoustic wave reflectivity capability;
the spatial pattern of the strips correlates with an identification code of the device.

5. The acoustic wave device as in claim 1,
wherein at least part of the device comprises piezoelectric material;
the piezoelectric material capable of converting vibrations into an electric voltage difference across at least a portion of the device.

6. The acoustic wave device as in claim 1, wherein the acoustic wave sensor portion comprises a plurality of sensors.

7. The acoustic wave device as in claim 1,
the acoustic wave sensor portion comprising an interdigital transducer section;
the acoustic wave sensor portion capable of using different vibration modes of the interdigital transducer section to sense different parameters respectively.

8. The acoustic wave device as in claim 1, wherein the acoustic wave sensor portion is capable of sensing at least one parameter from a group consisting of a physical parameter, an electrical parameter, a chemical parameter, temperature, pressure, torque, acceleration, impedance, distance, orientation, gas concentration, pH, fluid flow, viscosity, density, and magnetic field.

9. The acoustic wave device as in claim 1, further comprising:
an energy capturing element capable;
the energy capturing element capable of converting energy from environment near the device into energy for powering the device.

10. The acoustic wave device as in claim 9, further comprising:
rectification circuitry;
oscillation circuitry;
the rectification circuitry electrically connected to the energy capturing element;
the oscillation circuitry electrically connected to the rectification circuitry;
the oscillation circuitry electrically connected to the acoustic wave radio frequency identification portion;
the oscillation circuitry electrically connected to the acoustic wave sensor portion.

11. The acoustic wave device as in claim 9, wherein the energy capturing element comprises at least one element from a group consisting of a piezoelectric element, a thermal-electric element, a magnetoeleastic element, a piezoelectric-magnetoelastic element, a photo-acoustic element, and an opto-electric element.

12. An acoustic wave system, comprising:
the acoustic wave device as in claim 1;
an information station;
the information station comprising an information station antenna;
the information station comprising a receiver;
the receiver electrically connected to the information station antenna;
the information station comprising circuitry adapted to extract parameter information and identification information, respectively, from the sensor RF signal and the coded RF signal of the acoustic wave device.

13. A method for providing parameter information and identification information from an acoustic wave device, the method comprising:
generating an acoustic wave in at least a portion of the device;
reflecting back a coded acoustic signal when the acoustic wave is generated;
converting the coded acoustic signal to a coded RF signal;
transmitting the coded RF signal from an antenna;
modifying a characteristic of a sensor acoustic wave in at least a portion of the device, the modification depending on a parameter being sensed;
generating a sensor RF signal containing information about the parameter being sensed;
transmitting the sensor RF signal from the antenna.

14. The method as in claim 13, wherein the modifying step comprises separate modifications depending respectively on separate parameters being sensed.

15. The method as in claim 13,
the sensor acoustic wave comprising a plurality of waves corresponding, respectively, with a plurality of vibration modes of at least a portion of the device;
the modifying step comprising separate modifications, respectively, of at least some of the plurality of sensor acoustic waves.

16. The method as in claim 13, further comprising sensing at least one parameter from a group consisting of a physical parameter, an electrical parameter, a chemical parameter, temperature, pressure, torque, acceleration, impedance, distance, orientation, gas concentration, pH, fluid flow, viscosity, density, and magnetic field.

17. The method as in claim 13, further comprising converting energy from environment near the device into energy for powering the device.

18. The method as in claim 13, further comprising:
converting energy available from environment near the device to electrical energy;
rectifying current generated by the electrical energy;
converting the rectified current to a signal with a chosen frequency;
using the converted signal to generate the acoustic wave.

19. The method as in claim 13, further comprising:
receiving the coded RF signal and the sensor RF signal;
extracting the parameter information from the sensor RF signal;
extracting the identification information from the coded RF signal.

20. An acoustic wave device comprising:
means for generating an acoustic wave in at least a portion of the device;
means for reflecting back a coded acoustic signal when the acoustic wave is generated;
means for converting the coded acoustic signal to a coded RF signal;
means for transmitting the coded RF signal;
means for modifying a characteristic of a sensor acoustic wave in at least a portion of the device, the modification depending on a parameter being sensed;
means for generating a sensor RF signal containing information about the parameter being sensed;
means for transmitting the sensor RF signal.

21. The acoustic wave device as in claim 20, further comprising means for converting energy from environment near the device into energy for powering the device.

22. An acoustic wave system, comprising:
the acoustic wave device as in claim 20;
means for receiving the coded RF signal and the sensor RF signal;
means for extracting parameter information from the sensor RF signal and extracting the identification information from the coded RF signal.
